(19) United States
(12) Patent Application Publication
(10) Pub. No.: US 2019/0366574 A1
(43) Pub. Date: Dec. 5, 2019

(54) Composite Manufacturing System and Method

(71) Applicant: Aurora Flight Sciences Corporation, Manassas, VA (US)

(72) Inventors: William Bosworth, Cambridge, MA (US); Devin R. Jensen, Cambridge, MA (US); Konstantine Fetfatsidis, Manassas, VA (US)

(21) Appl. No.: 15/994,432

(22) Filed: May 31, 2018

(51) Int. Cl. B26D 5/00; G01N 29/04; G01N 29/22; G01N 29/265; G01N 29/44; B26D 7/01; G05B 19/418

(52) U.S. Cl. CPC B26D 5/007; G01N 29/048; G01N 29/225; G01N 29/265; B26F 1/3813; B26D 7/018; G05B 19/41875; G01N 2291/0231; G01N 2291/2632; G01N 29/4427

(57) ABSTRACT

A cutting machine for detecting a defect during a manufacturing process is disclosed. The cutting machine comprises a base structure having a planar surface defining a working area, a rack to support a material spool, a cutter assembly, and a material-inspection system. The rack may be positioned at an end of the base structure to facilitate unrolling of a composite material sheet from the material spool and onto the working area. The cutter assembly comprises a cutter tool to cut the composite material sheet on the working area. The cutter assembly may be configured to move relative to the working area via a two-axis gantry. The material-inspection system comprises a plurality of non-contact ultrasonic sensors to measure one or more material properties of the composite material sheet. The measured one or more material properties can be used to detect and predict defects in the composite material sheet.

### FIELD

The present disclosure is directed to composite structures; more particularly, to systems and methods for manufacturing composite structures.

### BACKGROUND

Composite structures are widely used in aircraft fabrication because they are generally lighter, more durable, and longer lasting when compared to aircraft structures fabricated from traditional aircraft materials (e.g., aluminum, aluminum alloys, etc.). Indeed, weight reduction is major advantage of composite material usage and is a key factor in using it in an aircraft structure. For example, fiber-reinforced matrix systems can be stronger than traditional aluminum found on most aircraft, while also providing smooth surfaces and increased fuel efficiency. Fiberglass, for example, is a common composite material used in composite structures for aircraft applications. In addition to weight saving benefits, composite materials do not corrode as easily as other types of structures. Further, composite structures do not crack from metal fatigue and they hold up well in structural flexing environments. Finally, composite materials are particularly useful when fabricating complex 3-dimensional (“3D”) structures, which typically offer a favorable strength-to-weight ratio compared to conventional metal or plastics manufacturing. Accordingly, in addition to lower weight, composite structures result in reduced maintenance and repair costs, while also enabling the fabrication of complex shapes.

Composite manufacturing, however, is generally more expensive compared many conventional metal manufacturing methods. This added cost can be attributed, at least in part, to the relatively complex and time-consuming manufacturing process, which historically required multiple steps. Notably, the manufacturing process includes a curing process during which the structure may spend hours or days in a controlled environment to achieve its required strength. Final inspection of the composite structure is used to verify structural and geometric integrity of the part. While analyzing the composite structure before use is very important, analyzing the composite structure during final inspection results in a considerable loss of productivity and revenue.

Therefore, a need exists for improved manufacturing systems and methods. To that end, the subject disclosure addresses the inspection of composite materials used in composite manufacturing. For example, during a first step in the manufacturing process, the composite material may be analyzed to identify defects in the composite material prior to assembly and cure of the composite structure.

### SUMMARY

The present disclosure is directed to composite structures; more particularly, to systems and methods for manufacturing composite structures.

According to a first aspect, a cutting machine for detecting a defect during a manufacturing process comprises: a base structure having a surface defining a working area; a rack to support a material spool, wherein the rack is positioned at an end of the base structure to facilitate unrolling of a composite material sheet from the material spool and onto the working area; a cutter assembly having a cutter tool to cut the composite material sheet, wherein the cutter assembly is configured to move relative to the working area; and a material-inspection system comprising a plurality of non-contact ultrasonic sensors to measure one or more material properties of the composite material sheet.

In certain aspects, the plurality of non-contact ultrasonic sensors comprises an ultrasonic emitter and an ultrasonic receiver.

In certain aspects, the ultrasonic emitter and the ultrasonic receiver are positioned on opposing sides of the composite material sheet during use.

In certain aspects, the ultrasonic emitter and the ultrasonic receiver are coaxially aligned.

In certain aspects, the ultrasonic emitter and the ultrasonic receiver are supported relative to the composite material sheet via a frame.

In certain aspects, the ultrasonic emitter and the ultrasonic receiver are configured to translate along the frame to scan the composite material sheet.

In certain aspects, the ultrasonic emitter and the ultrasonic receiver are configured to move in unison to maintain a coaxial alignment.

In certain aspects, the ultrasonic emitter and the ultrasonic receiver are configured to oscillate along at least one axis defined by the frame as the composite material sheet is unrolled from the material spool.

In certain aspects, the ultrasonic receiver is positioned within the base structure.

In certain aspects, the ultrasonic emitter and the ultrasonic receiver are magnetically coupled to one another to maintain a coaxial alignment.

In certain aspects, the material-inspection system is positioned adjacent the rack.

In certain aspects, the cutter assembly is configured to move relative to the working area via a two-axis gantry, the two-axis gantry comprising a first carriage and a second carriage, wherein the first carriage is configured to translate along a first axis relative to the second carriage via a first set of rails, wherein the second carriage is configured to translate along a second axis relative to the working area via a second set of rails, wherein the second carriage is substantially parallel to the rack.

In certain aspects, the ultrasonic emitter is coupled to the cutter assembly.

In certain aspects, the material-inspection system is positioned between the second carriage and the rack.

In certain aspects, the cutting machine further comprises a marking apparatus to mark visually any defective areas of the composite material sheet based at least in part on measurements from the plurality of non-contact ultrasonic sensors.

In certain aspects, the material-inspection system is operatively coupled with a tracking system, wherein the tracking system is communicatively coupled to a database of historic quality data.

In certain aspects, the tracking system is configured to predict defects in the composite material sheet based at least in part on measured material properties and data stored to the database of historic quality data.

In certain aspects, the material-inspection system is configured to communicate the measured material properties to the tracking system in real-time.

In certain aspects, the tracking system is configured to identify relationships between the material properties of the composite material sheet and performance of a cured structure.

In certain aspects, the plurality of non-contact ultrasonic sensors comprises a plurality of ultrasonic sensor pairs, wherein each of the plurality of ultrasonic sensor pairs comprises an ultrasonic emitter and an ultrasonic receiver, wherein the ultrasonic emitter and the ultrasonic receiver of each ultrasonic sensor pair are positioned on opposing sides of the composite material sheet as the composite material sheet is unrolled from the material spool.

In certain aspects, the plurality of non-contact ultrasonic sensors comprises an ultrasonic emitter and a plurality of ultrasonic receivers positioned within the base structure in a predetermine portion of the working area.

In certain aspects, the base structure comprises a vacuum system to pull the composite material sheet toward the working area via a plurality of vacuum holes.

In certain aspects, the composite material sheet is a sheet of pre-impregnated composite fibers.

In certain aspects, the cutting machine further comprises a position sensor to track a position of the material spool, wherein the position of the material spool is used to correlate material properties detected by the material-inspection system with an area of the composite material sheet.

In certain aspects, the material-inspection system further comprises one or more contact ultrasonic sensors.

According to a second aspect, a cutting machine for detecting a defect during a manufacturing process comprises: a base structure having a surface defining a working area; a rack to support a material spool, wherein the rack is positioned at an end of the base structure to facilitate unrolling of a composite material sheet from the material spool and onto the working area; a cutter assembly having a cutter tool to cut the composite material sheet, wherein the cutter assembly is configured to move relative to the working area; and a material-inspection system comprising a plurality of non-contact ultrasonic sensors to measure one or more material properties of the composite material sheet, wherein the plurality of non-contact ultrasonic sensors comprises an ultrasonic emitter and an ultrasonic receiver, and wherein each of the ultrasonic emitter and the ultrasonic receiver is configured to translate along the frame to scan the composite material sheet.

In certain aspects, the cutter assembly is configured to move relative to the working area via a two-axis gantry, the two-axis gantry comprising a first carriage and a second carriage, wherein the first carriage is configured to translate along a first axis relative to the second carriage via a first set of rails, wherein the second carriage is configured to translate along a second axis relative to the working area via a second set of rails, wherein the second carriage is substantially parallel to the rack.

In certain aspects, the cutting machine further comprises a marking apparatus to mark visually any defective areas of the composite material sheet based at least in part on measurements from the plurality of non-contact ultrasonic sensors.

In certain aspects, the material-inspection system is operatively coupled with a tracking system, wherein the tracking system is communicatively coupled to a database of historic quality data, wherein the tracking system is configured to predict defects in the composite material sheet based at least in part on measured material properties and data stored to the database of historic quality data.

According to a third aspect, a method for detecting a defect during a manufacturing process of a cutting machine comprises: unspooling a composite material sheet from a material spool and onto a working area of the cutting machine; scanning, via a material-inspection system, the composite material as it is unspooled from the material spool and onto a working area of the cutting machine; generating inspection data, via a material-inspection system, reflecting one or more material properties of the composite material sheet, wherein the material-inspection system comprising a plurality of non-contact ultrasonic sensors to measure the one or more material properties of the composite material sheet; and performing a cutting operation, via a cutter assembly, based at least in part on the inspection data, wherein the cutter assembly comprises a cutter tool to cut the composite material sheet and is configured to move relative to the working area.

In certain aspects, the method further comprises the step of visually marking, via a marking apparatus, one or more defective areas of the composite material sheet based at least in part on the inspection data.

In certain aspects, the method further comprises the step of predicting a defect in the composite material sheet based at least in part on the inspection data and data stored to a database of historic quality data.

In certain aspects, each of the plurality of non-contact ultrasonic sensors comprises an ultrasonic emitter and an ultrasonic receiver, each of the ultrasonic emitter and the ultrasonic receiver being configured to translate along the cutting machine to scan the composite material sheet.

In certain aspects, the method further comprises the step of magnetically coupling the ultrasonic emitter and the ultrasonic receiver of a non-contact ultrasonic sensor to one another to maintain a coaxial alignment.

### DESCRIPTION OF THE FIGURES

These and other advantages of the present disclosure will be readily understood with the reference to the following specifications and attached drawings wherein:

FIG. 1 illustrates an example automated two-dimensional ply cutting machine configured to cut a composite material sheet.

FIGS. 2a and 2b illustrate a cutting machine configured with a material-inspection system.

FIG. 2c illustrates a first example material-inspection system.

FIG. 2d illustrates a second example material-inspection system.

FIG. 3 illustrates an example cutting machine having embedded ultrasonic sensors.

FIG. 4 illustrates an example free-standing material-inspection system.

FIG. 5 illustrates a block diagram schematic of an example material-inspection system.

FIG. 6 illustrates a graph showing an estimate of the time required to scan the amount of composite material sheet at different resolutions.

### DESCRIPTION

Preferred embodiments of the present disclosure will be described hereinbelow with reference to the accompanying drawings. In the following description, certain well-known functions or constructions are not described in detail since they would obscure the disclosure in unnecessary detail. The figures are not necessarily to scale, emphasis instead being placed upon illustrating the principles of the devices, systems, and methods described herein. For this application, the following terms and definitions shall apply:

The terms “about” and “approximately,” when used to modify or describe a value (or range of values), mean reasonably close to that value or range of values. Thus, the embodiments described herein are not limited to only the recited values and ranges of values, but rather should include reasonable workable deviations.

The terms “aerial vehicle” and “aircraft” refer to a machine capable of flight, including, but not limited to, traditional aircraft and vertical takeoff and landing (VTOL) aircraft. VTOL aircraft may include both fixed-wing aircraft, rotorcraft (e.g., helicopters), and/or tilt-rotor/tilt-wing aircraft.

The terms “circuits” and “circuitry” refer to physical electronic components (e.g., hardware) and any software and/or firmware (“code”) which may configure the hardware, be executed by the hardware, and or otherwise be associated with the hardware. As used herein, for example, a particular processor and memory may comprise a first “circuit” when executing a first set of one or more lines of code and may comprise a second “circuit” when executing a second set of one or more lines of code. As utilized herein, circuitry is “operable” to perform a function whenever the circuitry comprises the necessary hardware and code (if any is necessary) to perform the function, regardless of whether performance of the function is disabled, or not enabled (e.g., by a user-configurable setting, factory trim, etc.).

The terms “communicate” and “communicating” as used herein, include both conveying data from a source to a destination and delivering data to a communications medium, system, channel, network, device, wire, cable, fiber, circuit, and/or link to be conveyed to a destination. The term “communication” as used herein means data so conveyed or delivered. The term “communications” as used herein includes one or more of a communications medium, system, channel, network, device, wire, cable, fiber, circuit, and/or link.

The term “composite material” as used herein, refers to a material comprising an additive material and a matrix material. For example, a composite material may comprise a fibrous additive material (e.g., fiberglass, glass fiber (“GF”), carbon fiber (“CF”), aramid/para-aramid synthetic fibers, etc.) and a matrix material (e.g., epoxies, polyimides, and alumina, including, without limitation, thermoplastic, polyester resin, polycarbonate thermoplastic, casting resin, polymer resin, acrylic, chemical resin). In certain aspects, the composite material may employ a metal, such as aluminum and titanium, to produce fiber metal laminate (FML) and glass laminate aluminum reinforced epoxy (GLARE). Further, composite materials may include hybrid composite materials, which are achieved via the addition of some complementary materials (e.g., two or more fiber materials) to the basic fiber/epoxy matrix.

The term “composite laminates” as used herein, refers to a type of composite material assembled from layers (i.e., a “ply”) of additive material and a matrix material.

The term “composite structure” as used herein, refers to structures or components fabricated, at least in part, using a composite material, including, without limitation, composite laminates.

The terms “coupled,” “coupled to,” and “coupled with” as used herein, each mean a relationship between or among two or more devices, apparatuses, files, circuits, elements, functions, operations, processes, programs, media, components, networks, systems, subsystems, and/or means, constituting any one or more of: (i) a connection, whether direct or through one or more other devices, apparatuses, files, circuits, elements, functions, operations, processes, programs, media, components, networks, systems, subsystems, or means; (ii) a communications relationship, whether direct or through one or more other devices, apparatuses, files, circuits, elements, functions, operations, processes, programs, media, components, networks, systems, subsystems, or means; and/or (iii) a functional relationship in which the operation of any one or more devices, apparatuses, files, circuits, elements, functions, operations, processes, programs, media, components, networks, systems, subsystems, or means depends, in whole or in part, on the operation of any one or more others thereof.

The term “data” as used herein means any indicia, signals, marks, symbols, domains, symbol sets, representations, and any other physical form or forms representing information, whether permanent or temporary, whether visible, audible, acoustic, electric, magnetic, electromagnetic, or otherwise manifested. The term “data” is used to represent predetermined information in one physical form, encompassing any and all representations of corresponding information in a different physical form or forms.

The term “database” as used herein means an organized body of related data, regardless of the manner in which the data or the organized body thereof is represented. For example, the organized body of related data may be in the form of one or more of a table, map, grid, packet, datagram, frame, file, email, message, document, report, list, or in any other form.

The term “exemplary” means “serving as an example, instance, or illustration.” The embodiments described herein are not limiting, but rather are exemplary only. It should be understood that the described embodiments are not necessarily to be construed as preferred or advantageous over other embodiments. Moreover, the terms “embodiments of the invention,” “embodiments,” or “invention” do not require that all embodiments of the disclosure include the discussed feature, advantage, or mode of operation.

The term “memory device” means computer hardware or circuitry to store information for use by a processor. The memory device can be any suitable type of computer memory or any other type of electronic storage medium, such as, for example, read-only memory (ROM), random access memory (RAM), cache memory, compact disc read-only memory (CDROM), electro-optical memory, magneto-optical memory, programmable read-only memory (PROM), erasable programmable read-only memory (EPROM), electrically-erasable programmable read-only memory (EEPROM), a computer-readable medium, or the like.

The term “network” as used herein includes both networks and inter-networks of all kinds, including the Internet, and is not limited to any particular network or inter-network.

The term “processor” means processing devices, apparatuses, programs, circuits, components, systems, and subsystems, whether implemented in hardware, tangibly embodied software, or both, and whether or not it is programmable. The term “processor” includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing. The processor may be, for example, any type of general purpose microprocessor or microcontroller, a digital signal processing (DSP) processor, an application-specific integrated circuit (ASIC). The processor may be coupled to, or integrated with, a memory device.

Composite structures, such as those used in aircraft structures, can be fabricated using sheets of composite material, also known as layers or plies. Multiple composite material sheets may be assembled to form a composite laminate or other composite structure. In certain aspects, the composite material sheet may comprise both an additive material and a matrix material. More specifically, the composite material sheet may comprise composite fibers where a bonding material, such as resin or epoxy, is already present in the composite fibers; an arrangement that is more commonly known as “pre-impregnated” composite fibers or “pre-preg,”for short. A pre-preg material is initially flexible and somewhat sticky, but becomes hard and stiff once it has been heated (i.e., during the curing process) and cooled. Composite material sheets may be delivered as a roll using a spool. In use, the composite material sheet may be unrolled from the spool and cut to achieve a desired size and shape.

Before a composite structure is used, it is typically inspected to verify its structural and geometric integrity. Often, a defect in the composite structure can be attributed, or otherwise linked, to a defect in the composite material sheet. At this stage in the manufacturing process, however, a substantial amount of time, effort, and cost may have been expended to fabricate and cure the composite structure. Accordingly, to reduce waste of valuable manufacturing resources, it would be advantageous to perform material inspection during (or immediately prior) a first cutting step to thereby avoid cutting and employing defective composite material to fabricate a composite structure. To that end, the subject disclosure provides a system and method to facilitate the inspection of composite material (e.g., composite material sheets) during the manufacturing process of composite structures. More specifically, the disclosure addresses describes a material-inspection system and a two-dimensional ply-cutting machine having a material-inspection system to analyze the structural integrity of the composite material during the initial steps of the manufacturing process (e.g., as the composite material sheet is unrolled from the spool).

The disclosed material-inspection system can facilitate a number of unique capabilities. First, placement of a material-inspection system directly on the cutting machine/process can save both space and time. Second, integration of the material-inspection system with the cutting machine can avoid cutting in portions of defective composite material and can re-cut parts that overlap with defective areas. Finally, inspection data gathered by the material-inspection system from individual parts (e.g., composite material cut to a predetermined shaped) can be tracked through the life of the parts to generate a database of historic material qualities. This tracked historic data can aid in future debugging activities. For example, the historic data may be referenced by the material-inspection system (or another system) to identify as-yet-unknown relationships between material properties at the beginning of manufacturing to the final performance of the parts.

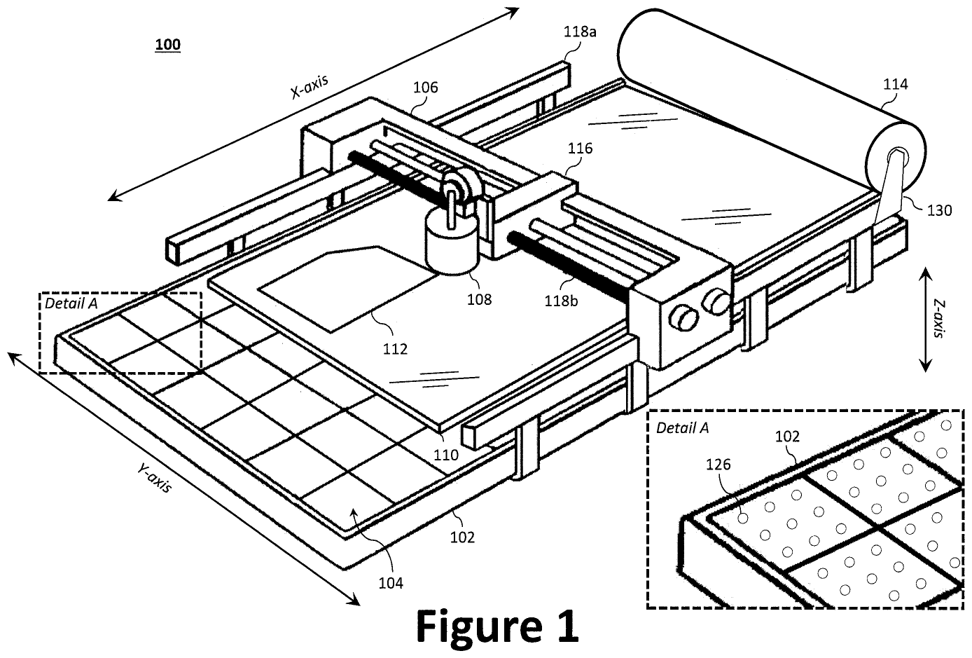

FIG. 1 illustrates an example automated two-dimensional ply cutting machine 100 configured to cut a composite material sheet 110 into individual parts/pieces for composite structure manufacturing. The cutting machine 100 is typically used during the first step of manufacturing composite assemblies (e.g., composite structures). As illustrated, the cutting machine 100 generally comprises a moveable cutter assembly 108 and a base structure 102 having a planar surface that defines a working area 104 (e.g., a working bed). The composite material sheet 110 may be unrolled from a material spool 114 mounted to a support rack 130 at one end (e.g., the back end) of the base structure 102 of the cutting machine 100 in order to facilitate laying the materials onto the table of the cutting machine 100. For example, a technician may pull the composite material sheet 110 from the material spool 114 and lay it upon the working area 104 for cutting. The material spool 114 may be a roll of pre-preg material that may have defects.

The base structure 102 may be sized to provide a working area 104 of virtually any size, which may be dictated by the composite structure to be fabricated of the size of the material spool 114 (e.g., its width). In one aspect, the working area 104 may be, for example, 6 feet wide by 15 feet long; although other sizes and aspect ratios are contemplated. The base structure 102 may further comprise a vacuum system 128 that gently pulls the composite material sheet 110 toward the working area 104 (e.g., into the table via suction force) during the cutting process. Accordingly, the soft vacuum system 128 causes the composite material sheet 110 to lie flat (e.g., substantially devoid of wrinkles/air pockets between the composite material sheet 110 and surface of the working area 104), while also mitigating movement of the composite material sheet 110 during the cutting process. To that end, the working area 104 may be provided with a plurality of vacuum holes 126 distributed across its surface through which air can be drawn, via a vacuum system 128, into the base structure 102.

In operation, the cutter assembly 108 is used to form a cut 112 in the composite material sheet 110 to define a part of a desired (e.g., predetermined) shape. The cutter assembly 108 generally comprises a cutter tool (e.g., a rotary or reciprocating cutter tool or blade) to cut the composite material sheet 110. The cutter tool may be driven by an electric drive motor. For example, the cutter tool may be coupled to the drive motor via the spindle and/or a quill (e.g., an extendable part of the spindle). The cutter tool may be removably coupled to the spindle using, for example, a chuck and chuck key. The spindle may be configured to couple with various cutter tools of different types and sizes. For example, the spindle may accept cutter tool bits with a ⅛ inch shank, but can be adjusted to accommodate shanks of other sizes (e.g., 3/16 inch, ¼ inch, ½ inch, etc.) using, inter alia, an adjustable spindle and/or an adapter.

The cutter assembly 108 is configured to move relative to the working area 104 via a gantry (e.g., a two-axis gantry, such as an X-Y gantry). The X-Y gantry generally comprises a first carriage 106, a second carriage 116 (e.g., a shuttle), a first set of rails 118a, and a second set of rails 118b. The first carriage 106 may be used to control movement of the cutter assembly 108 relative to the working area 104 along the X-axis, while the second carriage 116 may be used to control movement of the cutter assembly 108 relative to the working area 104 along the Y-axis. As illustrated, to provide movement along the X and Y axis, the first carriage 106 may be slideably coupled to the base structure 102 via a first pair of rails 118a (illustrated as parallel to the X-axis/longitudinal axis of the base structure 102), while the second carriage 116 may be configured to translate along the Y-axis along a second set of rails 118b (illustrated as parallel to the Y-axis/lateral axis of the base structure 102). In certain aspects, the cutter assembly 108 may be coupled to the second carriage 116 via a third rail (or track) such that the cutter assembly 108 can move relative to the working area 104 and the second carriage 116 along the Z-axis (i.e., up and down).

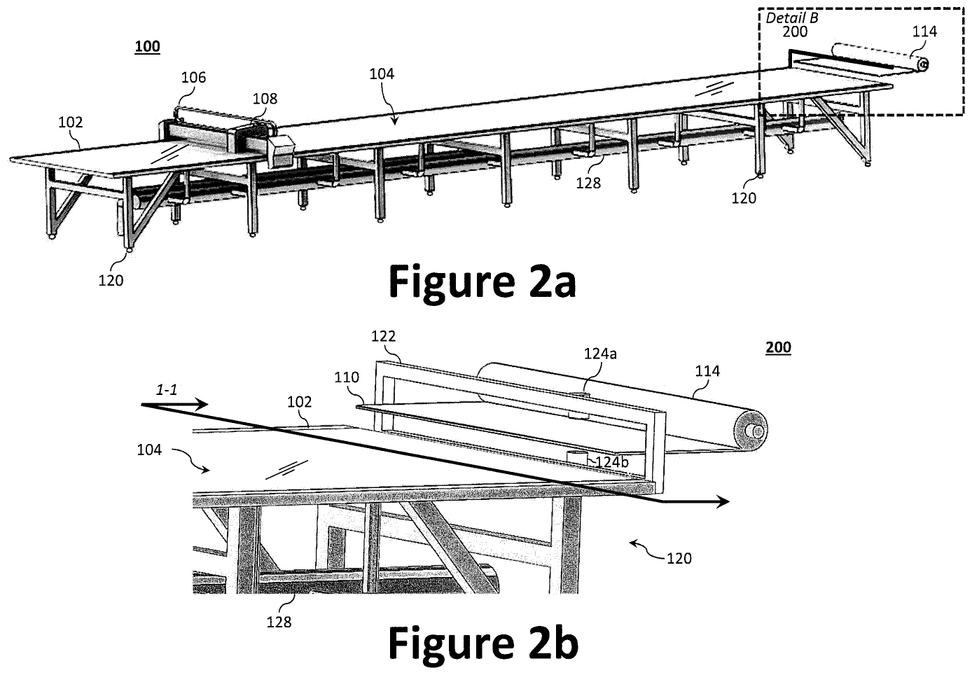

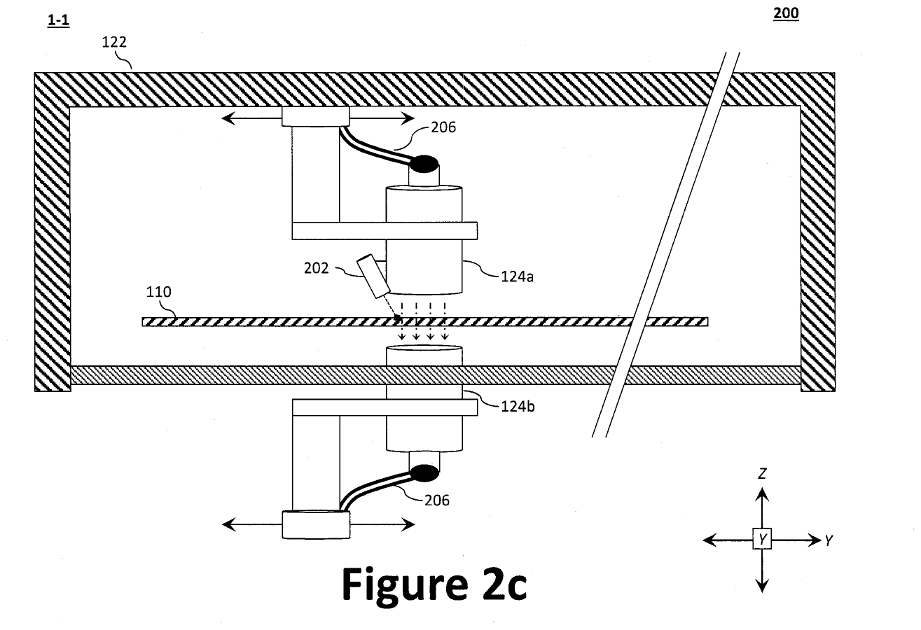

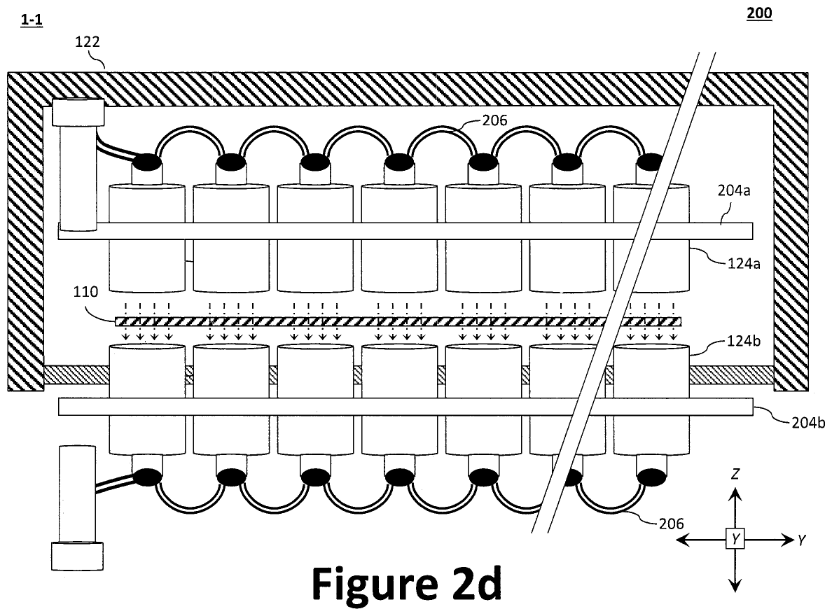

With reference to FIGS. 2a through 2d, the cutting machine 100 of FIG. 1 may be configured with one or more varieties of material-inspection systems 200 to analyze one or more qualities of the composite material sheet 110 as it is unrolled from the material spool 114.

The material-inspection system 200 may be structure placed near material spool 114. The material-inspection system 200 may contains non-contact ultrasonic probes (or other probes), which are used to measure the structural integrity of the composite material sheet 110 as it is unrolled onto the working area 104. As illustrated, the material-inspection system 200 may be positioned at the back end of the base structure 102, adjacent and parallel to the material spool 114. The material-inspection system 200 serves to reduce manufacturing time by providing automated composite manufacturing and quality control. For example, the cutting machine 100 may be configured to inspect the composite material sheet 110 via the material-inspection system 200 as it is being unrolled from the material spool 114 and onto the working area 104, thereby obviating the need to wait until the composite structure is complete and the need to move the composite material sheet 110 (or the resulting composite structure) to a new table/machine exclusively for inspection.

As noted above, identifying manufacturing defects early in the manufacturing process eliminates expensive and time consuming fabrication of composite structures using defective material. Therefore, an advantage of integrating inspection with the first use of the composite material sheet 110 is that defective areas of the material roll can be identified and eliminated quickly. Further, general information of material properties immediately prior to manufacturing can be collected by the material-inspection system 200 and used to develop the database of historic material qualities. For example, the historic material qualities may provide important measurements to a tracking system for debugging parts that are found to be defective in later assembly steps. Finally, building the material-inspection system 200 into the first manufacturing process addresses the performance of early material inspection without requiring a dedicated inspection station or inspection table. Therefore, rather than creating a unique space for the inspection, the material-inspection system 200 may be integrated directly onto the cutting machine 100 to provide space savings.

An objective of early inspection is to identify defects in the composite material sheet 110 before beginning work. In operation, these defects may be detected immediately by the material-inspection system 200 and used to prompt the operator to take action. For example, depending on the size or amount of defects, the operator may replace the material spool 114 or avoid the region affected by the defect. In certain aspects, the material-inspection system 200 may be configured to confirm that the correct type of composite material sheet 110 has been loaded for the desired composited structure. For example, the material-inspection system 200 may confirm that thickness, type of material, level of impregnation, etc. are correct (e.g., within a predetermined range).

Data from the material-inspection system 200 may be collected using a tracking system and stored to a database of historic quality data. The database may then be referenced by the tracking system (or another system) and used to investigate the potential causes or sources of defects found in later inspection steps. For example, historic quality data of the composite material sheets 110 may be compared to a later-discovered defect in order to identify any correlations between the qualities of the composite material sheet 110 and the later-discovered defect. In certain aspects, for example, the historic quality data may be used to generate a look up table that can be used to identify potentially defective composite material sheets 110. In other aspects, machine-learning techniques may be used to detect and/or predict potentially defective composite material sheets 110.

The material-inspection system 200 may employ one or more non-destructive-testing techniques to inspect the composite material sheet 110 in real-time or near real-time. For example, the material-inspection system 200 may comprise an ultrasound system having one or more non-contact ultrasonic sensors (e.g., a pair of ultrasonic sensors 124 comprising an ultrasonic emitter 124a and an ultrasonic receiver 124b). Non-contact ultrasonic sensors serve to simplify the inspection process and to enable the use of the sensors without needing to re-certify an existing manufacturing process, thereby allowing existing systems and processes to be quickly retrofitted. For example, ultrasound, via one or more ultrasonic sensors, may be used to verify impregnation levels of the composite material sheet 110 throughout its area. Therefore, the integration of material inspection into the cutting table can reduce a material-handling step and save space inside the manufacturing facility.

FIG. 2c illustrates an enlargement of a first example material-inspection system 200 as viewed along cut line 1-1 of FIG. 2a. As illustrated, the material-inspection system 200 comprises a pair of non-contact ultrasonic sensors 124 having an ultrasonic emitter 124a and an ultrasonic receiver 124b, where ultrasonic emitter 124a and the ultrasonic receiver 124b are positioned on opposing sides of the composite material sheet 110 that is to be inspected. Each of the ultrasonic emitter 124a and the ultrasonic receiver 124b may be positioned on a frame 122 (e.g., one or more linear rails) that is positioned adjacent and substantially parallel to the longitudinal length of the material spool 114. In other words, the material-inspection system 200 may be placed between the material spool 114 and the working area 104 and arranged to analyze the composite material sheet 110 as it unrolled onto the working area 104 of the base structure 102.

To analyze the composite material sheet 110 along its entire width (Y-axis), the ultrasonic sensors 124 may be configured to translate along the frame 122. For example, each of the ultrasonic sensors 124 may be coupled to a mount configured to travel along the frame 122 linearly along the Y-axis via a rail/track and one or more actuators. The ultrasonic sensors 124 may be configured to communicate with a controller system via one or more cables 206.

As can be appreciated, the ultrasonic emitter 124a and the ultrasonic receiver 124b preferably move in unison to maintain alignment (e.g., a coaxial alignment) between the ultrasonic sensors 124. In operation, the ultrasonic sensors 124 may travel back and forth (e.g., oscillate) along the Y-axis as the composite material sheet 110 is unrolled, thereby scanning the entire surface of the composite material sheet 110.

While an X-Y plotter may be used to control the location of the ultrasonic sensors 124, a challenge to this approach, however, is that the non-contact ultrasonic sensor should be above and below the material. Therefore, the lower ultrasonic sensor (ultrasonic receiver 124b) must be configured to avoid other devices positioned on the under-side of the cutting table, such the pipes of the vacuum system 128. Accordingly, as illustrated in FIG. 2b, the material-inspection system 200 may be suspended off the edge of the base structure 102 so as to avoid interference with components of the base structure 102. Alternatively, multiple sets of ultrasonic sensors 124 may be linearly and fixedly placed across the frame 122 on a set of brackets (e.g., upper and lower brackets 204a, 204b), an example of which is illustrated in FIG. 2d, thereby obviating the need to translate a single set of ultrasonic sensors 124 along the frame 122. FIG. 2d illustrates an enlargement of a second example material-inspection system 200 as viewed along cut line 1-1 of FIG. 2a.

In either case, the collected data from the ultrasonic sensors 124 may be used to generate a map of the composite material sheet 110 to indicate the qualities of the various regions of the composite material sheet 110. Optionally, the material-inspection system 200 may further include a marking apparatus 202 to mark visually defective areas. For example, the marking apparatus 202 may be a dot or stripe printer, which may be a non-contact, programmable printer configured to mark dots or stripes for inspection marking, color coding, or other product identification. Alternatively, the marking apparatus 202 may be an industrial ink jet printer, which may be a non-contact, programmable printer configured to print information such as text, logos, date and time. In one aspect, the marking apparatus 202 may be coupled to one or more of the ultrasonic sensors 124 (e.g., the ultrasonic emitter 124a to mark the top surface of the composite material sheet 110). For example, upon determining that a portion of the composite material sheet 110 is defective, material-inspection system 200 may, via the marking apparatus, spray paint, ink, or another marker to indicate that the region is defective. In certain aspects, the marking apparatus 202 may draw a line around the affected (defective) area. A human operator may then visually inspect the composite material sheet 110 to analyze and/or avoid the region. In another aspect, an optical system may be used to detect one or more marks from the marking apparatus 202. The ink may be visible to the human eye or invisible. When an optical system is used, for example, an invisible ink (e.g., ultraviolet light (UV) ink, infrared (IR) ink, etc.) may be visible under certain lights or via certain optical systems.

In certain aspects, the material-inspection system 200 may also track/measure position and rate of the composite material sheet 110 as it is unspooled. Tracking the position of the composite material sheet 110 and/or material spool 114 enables the material-inspection system 200 to associate the ultrasound measurements with a region of the composite material sheet 110. The position and rate may be monitored using one or more optical trackers and/or a position sensor position on the material spool 114 (e.g., to count the revolutions of the spool). For example, the position of the roll as the composite material sheet 110 is being pulled across the ultrasonic sensors may be determined by measuring the angular position of the roll (using an angular encoder), by measuring the front of roll as it being pulled (using a camera or laser sensor), or by using optical flow on the ultrasonic structure itself. The unrolling may also be controlled by using an additional actuator to pull the rolls across the table. For example, the material spool 114 may be automatically unrolled at a controlled rate to facilitate the inspection of the composite material sheet 110.

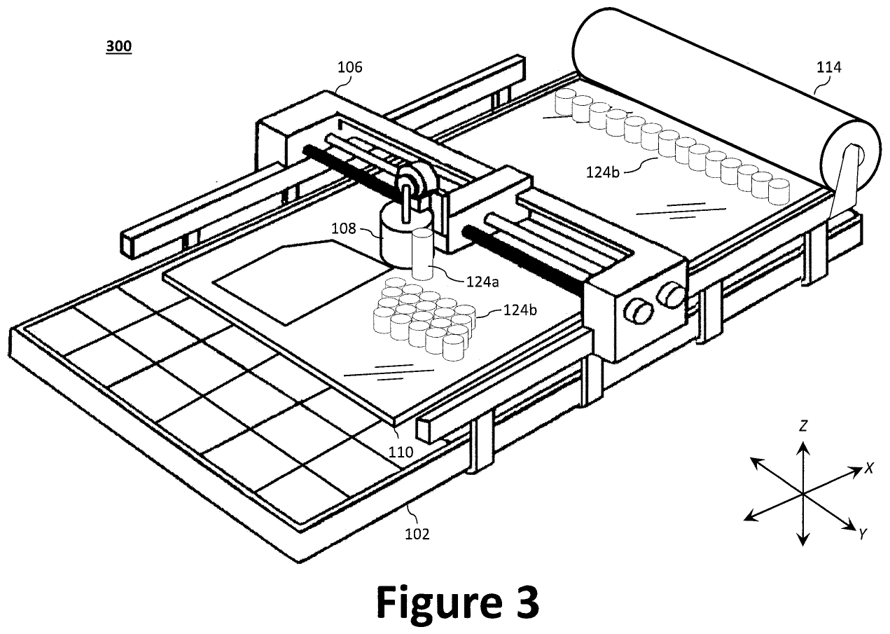

When it may not be feasible to position an ultrasonic sensor below the composite material sheet 110, an ultrasonic sensor system may be positioned only on the top side of the composite material sheet 110, however, at the possible expense of lower performance. Another strategy to address this would be to embed sensors into the base structure 102. For example, as illustrated in FIG. 3, a plurality of ultrasonic receivers 124b may be embedded within the base structure 102 to cover the entire working area 104 or in a single line adjacent the material spool 114. In FIG. 3, the embedded ultrasonic receivers 124b are drawn in phantom lines as a cluster and as a linear strip.

In this architecture, the ultrasonic package can be carried by the same X-Y plotter that carries the cutting head. As illustrated, rather than having a dedicated gantry system for the ultrasonic emitter 124a, the ultrasonic emitter 124a may be coupled to the cutter assembly 108. A separate X-Y plotter could be used by the ultrasonic sensors, if desired. In operation, the ultrasonic emitter 124a may scan a region of the composite material sheet 110 prior to cutting the part. This arrangement may necessitate embedding ultrasonic receivers 124b within the base structure 102 to cover all or a substantial portion of the working area 104. Alternatively, to reduce the number of the ultrasonic receivers 124b, a linear strip of embedded ultrasonic receivers 124b may be positioned adjacent the material spool 114 (as illustrated) such that the first carriage 106 travels toward the material spool 114 to perform its scanning as the composite material sheet 110 is unspooled. Once the desired amount of composite material sheet 110 is unspooled, the first carriage 106 may return to an area to perform its cutting operation.

While multiple ultrasonic receivers 124b are illustrated, a single ultrasonic receiver 124b may be embedded that moves with the ultrasonic emitter 124a. For example, the ultrasonic emitter 124a may be magnetically coupled to the embedded ultrasonic receiver 124b such that the ultrasonic receiver 124b is pulled across the underside surface of the working area 104 as the ultrasonic emitter 124a (and cutter assembly 108) is moved.

While integrating the material-inspection system 200 offers a number of advantages (e.g., saving time and space), the material-inspection system 200 may instead be offer as a separate device. Indeed, another strategy is to inspect the material roll before it is moved to the cutting machine 100. For example, a tape machine arrangement could transfer material between two rolls, with a scanner placed in between. Therefore, the composite material sheet 110 from the material spool 114 may be analyzed as they are received from the manufacturer, prior to installation on a cutting machine 100.

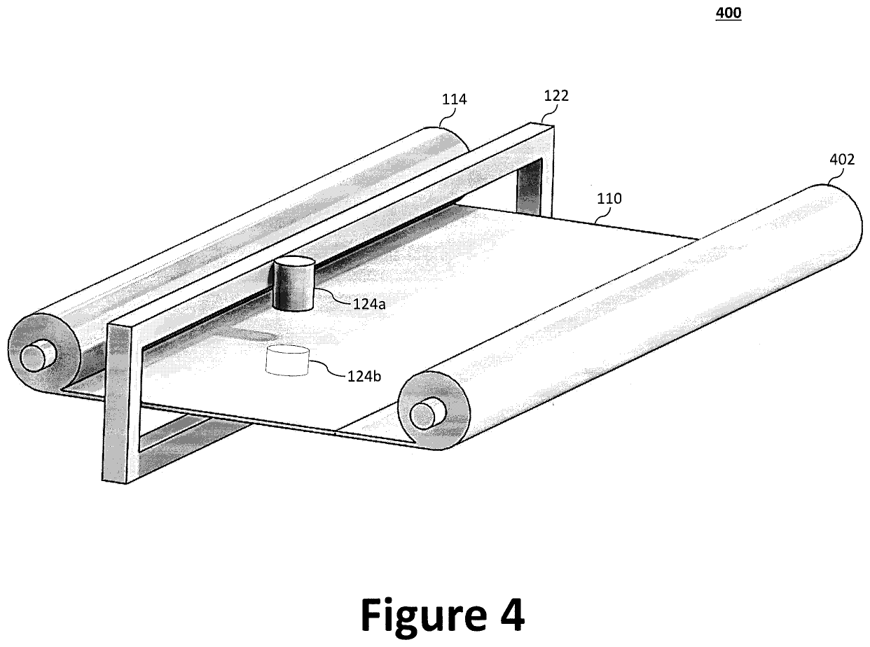

FIG. 4 illustrates an example free-standing material-inspection system 400. The free-standing material-inspection system 400 operates in substantially the same manner as the material-inspection system 200 of FIG. 2b; however, instead of unrolling the composite material sheet 110 onto the working area 104 to be cut by the 108, the composite material sheet 110 is instead roll around a second spool 402. The free-standing material-inspection system 400, in effect, analyzes the composite material sheet 110 as it is transferred from the first spool 114 to a second spool 402. Defective regions may be marked and/or stored to the database for use by the tracking system during a subsequent cutting operation.

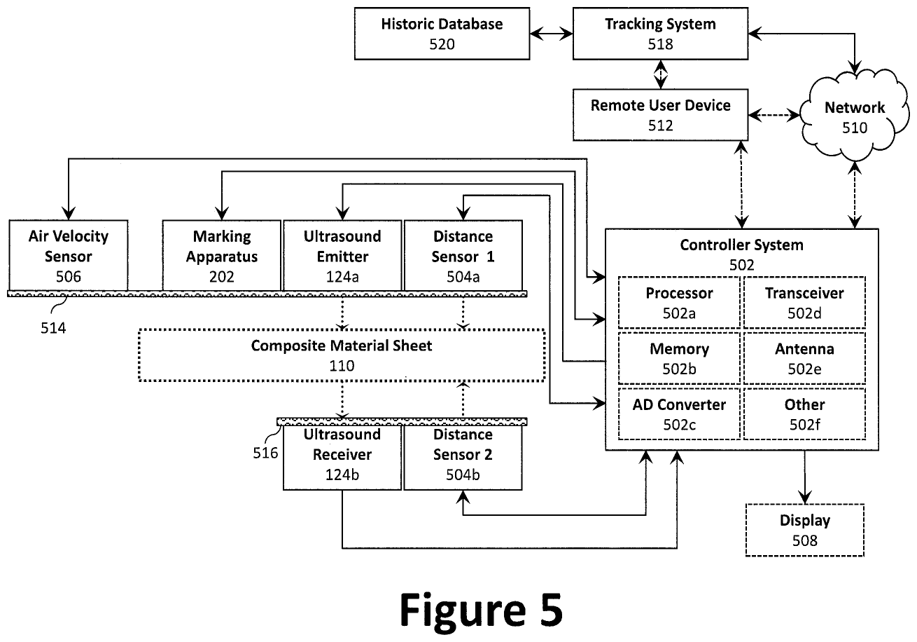

FIG. 5 illustrates a block diagram schematic of an example material-inspection system 200. As illustrated, the material-inspection system 200 comprises a controller system 502 operatively coupled to each of a display 508, a remote user device (whether directly or via a network 510), an air velocity sensor 506, a marking apparatus 202, a pair of ultrasonic sensors 124, and a pair of distance sensors 504. A first support 514 holds the ultrasonic emitter 124a, the first distance sensor 504a, the marking apparatus 202, and the air velocity sensor 506 in a first plane relative to the composite material sheet 110 while a second support 516 holds the ultrasonic receiver 124b and the second distance sensor 504b in a second plane that is substantially parallel to the first plane. The first support 514 and the second support 516 may be, for example, the upper and lower linear lateral spans of the frame 122.

As illustrated, a composite material sheet 110 is passed between each of the pairs of ultrasonic sensors 124 and distance sensors 504 such that the ultrasonic emitter 124a and the first distance sensor 504a are positioned on the top side of the composite material sheet 110 and the ultrasonic receiver 124b and the second distance sensor 504b are positioned on the underside of the composite material sheet 110. The air velocity sensor 506 may be an ultrasonic transducer operating in pulse-echo mode, while each of the first and second distance sensors 504a, 504b may be laser distance sensors. The first and second distance sensors 504a, 504b output an analog signal proportional to the distance to the composite material sheet 110, which may provide a sensing distance of 40 plus or minus 10 mm and a resolution of 2 microns.

The controller system 502 may comprise a processor 502a, a memory device 502b, an analog-to-digital converter 502c, a transceiver 502d, an antenna 502e, and, where desired, other systems 502f The processor 502a is operatively coupled to, or integrated with, the memory device 502b. The processor 502a may be configured to perform one or more operations based at least in part on instructions (e.g., software) and one or more databases stored to the memory device 502b (e.g., hard drive, flash memory, or the like). The analog to digital convert 502c translates the sensor inputs (analog) from the various sensors into a form (digital) for processing by the processor 502a.

The controller system 502 may further include a wireless transceiver 502d coupled with an antenna 502e to communicate data between the material-inspection system 200 and a remote user device 512 (e.g., portable electronic devices, such as smartphones, tablets, and laptop computers) or other controller (e.g., an office). For example, the material-inspection system 200 may communicate data (processed data, unprocessed data, etc.) with the remote user device 512 over a network 510. In certain aspects, the wireless transceiver 502d may be configured to communicate using one or more wireless standards such as Bluetooth (e.g., short-wavelength, Ultra-High Frequency (UHF) radio waves in the Industrial, Scientific, and Medical (ISM) band from 2.4 to 2.485 GHz), near-field communication (NFC), Wi-Fi (e.g., Institute of Electrical and Electronics Engineers' (IEEE) 802.11 standards), etc. The remote user device 512 may facilitate monitoring and/or control of the material-inspection system 200. As illustrated, the remote user device 512 may be used to access the tracking system 518, either direction or via a network 510, to access a historic database 520. As explain above, the tracking system 518 may be used to collect data from the material-inspection system 200 to create a historic database 520 of historic quality data. For example, the tracking system 518 may log the measured properties of the composite material during the unrolling phase, which can be used to immediately discard defected parts, or during investigation of any future-discovered defective assembly. The tracking system 518 may be provided via a computer, which may be networked to other computers in the manufacturing facility.

The controller system 502 may further include other desired services and systems 502f. For example, the controller system 502 may be provided with internally integrated or an external transmitting transducer excitation mechanism, such as a pulser, and a receiving transducer amplification mechanism, such as a receiver amplifier.

The scanning time for a large material spool 114 is dependent on the rate of performing a single measurement, the time required to move the sensor from point to point, and the required scanning resolution. The material-inspection system 200 may be configured to operate physically with a control bandwidth of, for example, approximately 5 Hz—i.e., each scan position will require 0.2 seconds to move physically the material and sensor. Additionally, the measurement may be performed at, for example, approximately 33 Hz—i.e., in 0.03 seconds. For example, this measurement time may be based on a 100 Hz measurement bandwidth of the ultrasonic sensors and the expected settling time of the actuator.

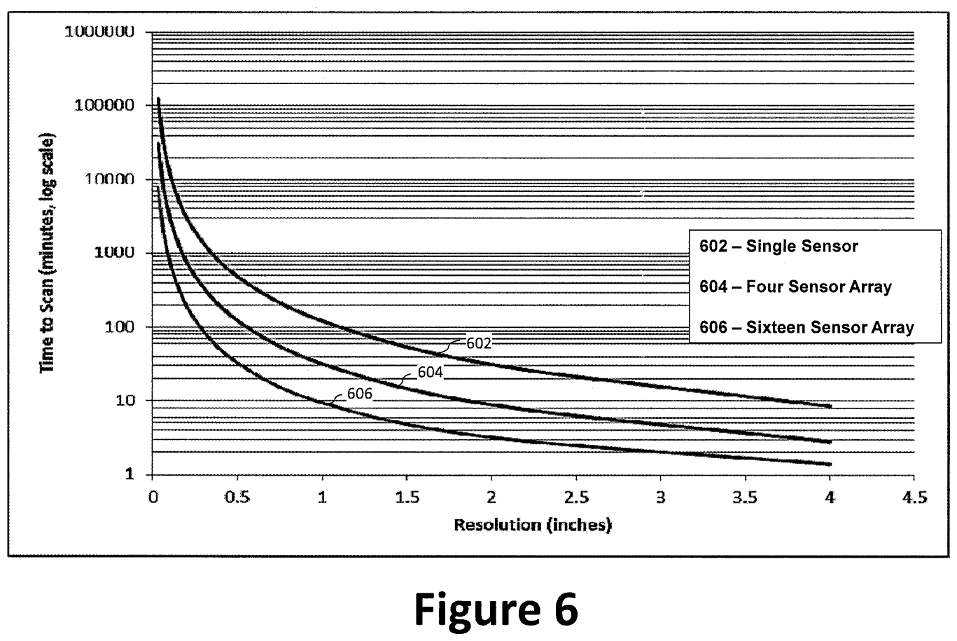

FIG. 6 illustrates a graph showing an estimate of the time required to scan the amount of composite material sheet 110 that is placed onto the cutting machine 100. The analysis was performed for both a single sensor set up 602 and a set up that would include multiple sensors in an array, 604, 606. For a single sensor system 602, scan resolutions of greater than 1.5 inches allow total scan times under 1 hour. If a higher upfront cost is tolerable an array of 16 sensors would a scan in less than an hour at a 0.5-inch resolution.

Another concept is to intentionally contact sections of the composite material sheet 110 on the working area 104, which will be used in destructive material tests. In order to avoid affecting current airworthiness and customer approvals, cut paths may be planned to avoid areas where the sensor contacts the material. In certain aspects, the contact-sensor could automatically mark the affected area to ensure it was not used. Therefore, even if the material passes inspection, it should not be used due to being contacted as part of the testing. The benefit of this method is that it obviates the need for non-contact ultrasonic sensors, which are typically must more expensive than contact-based ultrasonic sensors. This concept would have similar scanning time performance.

In another aspect, the composite structures may be weighed after cutting to identify defects. For example, each composite structure may be weighed as it comes off the cutting machine 100. The measured weight may be compared to an expected value (i.e., weight) that is calculated based on the volume and density of the composite structure. In other words, a composite structure that has an unexpected mass does not have a proper amount of pre-preg material. A benefit of this approach is that it should be inexpensive to begin implementing by hand, at a rate of approximately three measurements per minute by a single technician. Additional streamlining of the process could be developed if the method appears valuable.

What is claimed is:

1. A cutting machine for detecting a defect during a manufacturing process, the cutting machine comprising:
a base structure having a surface defining a working area;
a rack to support a material spool, wherein the rack is positioned at an end of the base structure to facilitate unrolling of a composite material sheet from the material spool and onto the working area;
a cutter assembly having a cutter tool to cut the composite material sheet, wherein the cutter assembly is configured to move relative to the working area; and
a material-inspection system comprising a plurality of non-contact ultrasonic sensors to measure one or more material properties of the composite material sheet.

2. The cutting machine of claim 1, wherein the plurality of non-contact ultrasonic sensors comprises an ultrasonic emitter and an ultrasonic receiver positioned on opposing sides of the composite material sheet during use.

3. The cutting machine of claim 2, wherein the ultrasonic emitter and the ultrasonic receiver are configured to translate along a frame to scan the composite material sheet.

4. The cutting machine of claim 3, wherein the ultrasonic emitter and the ultrasonic receiver are configured to move in unison to maintain a coaxial alignment.

5. The cutting machine of claim 3, wherein the ultrasonic emitter and the ultrasonic receiver are configured to oscillate along at least one axis defined by the frame as the composite material sheet is unrolled from the material spool.

6. The cutting machine of claim 1, wherein the cutter assembly is configured to move relative to the working area via a two-axis gantry, the two-axis gantry comprising a first carriage and a second carriage, wherein the first carriage is configured to translate along a first axis relative to the second carriage via a first set of rails, wherein the second carriage is configured to translate along a second axis relative to the working area via a second set of rails, wherein the second carriage is substantially parallel to the rack.

7. The cutting machine of claim 1, further comprising a marking apparatus to mark visually any defective areas of the composite material sheet based at least in part on measurements from the plurality of non-contact ultrasonic sensors.

8. The cutting machine of claim 1, wherein the material-inspection system is operatively coupled with a tracking system, wherein the tracking system is communicatively coupled to a database of historic quality data.

9. The cutting machine of claim 8, wherein the tracking system is configured to predict defects in the composite material sheet based at least in part on measured material properties and data stored to the database of historic quality data.

10. The cutting machine of claim 8, wherein the tracking system is configured to identify relationships between the material properties of the composite material sheet and performance of a cured structure.

11. The cutting machine of claim 1, wherein the plurality of non-contact ultrasonic sensors comprises a plurality of ultrasonic sensor pairs, wherein each of the plurality of ultrasonic sensor pairs comprises an ultrasonic emitter and an ultrasonic receiver, wherein the ultrasonic emitter and the ultrasonic receiver of each ultrasonic sensor pair are positioned on opposing sides of the composite material sheet as the composite material sheet is unrolled from the material spool.

12. The cutting machine of claim 1, wherein the base structure comprises a vacuum system to pull the composite material sheet toward the working area via a plurality of vacuum holes.

13. The cutting machine of claim 1, further comprising a position sensor to track a position of the material spool, wherein the position of the material spool is used to correlate material properties detected by the material-inspection system with an area of the composite material sheet.

14. The cutting machine of claim 1, wherein the material-inspection system further comprises one or more contact ultrasonic sensors.

15. A cutting machine for detecting a defect during a manufacturing process, the cutting machine comprising:
a base structure having a surface defining a working area;
a rack to support a material spool, wherein the rack is positioned at an end of the base structure to facilitate unrolling of a composite material sheet from the material spool and onto the working area;
a cutter assembly having a cutter tool to cut the composite material sheet, wherein the cutter assembly is configured to move relative to the working area; and
a material-inspection system comprising a plurality of non-contact ultrasonic sensors to measure one or more material properties of the composite material sheet,
wherein the plurality of non-contact ultrasonic sensors comprises an ultrasonic emitter and an ultrasonic receiver, and
wherein each of the ultrasonic emitter and the ultrasonic receiver is configured to translate along the frame to scan the composite material sheet.

16. The cutting machine of claim 15, further comprising a marking apparatus to mark visually any defective areas of the composite material sheet based at least in part on measurements from the plurality of non-contact ultrasonic sensors.

17. The cutting machine of claim 15, wherein the material-inspection system is operatively coupled with a tracking system, wherein the tracking system is communicatively coupled to a database of historic quality data, wherein the tracking system is configured to predict defects in the composite material sheet based at least in part on measured material properties and data stored to the database of historic quality data.

18. A method for detecting a defect during a manufacturing process of a cutting machine, the method comprising:
unspooling a composite material sheet from a material spool and onto a working area of the cutting machine;
scanning, via a material-inspection system, the composite material as it is unspooled from the material spool and onto a working area of the cutting machine;
generating inspection data, via a material-inspection system, reflecting one or more material properties of the composite material sheet, wherein the material-inspection system comprising a plurality of non-contact ultrasonic sensors to measure the one or more material properties of the composite material sheet; and
performing a cutting operation, via a cutter assembly, based at least in part on the inspection data, wherein the cutter assembly comprises a cutter tool to cut the composite material sheet and is configured to move relative to the working area.

19. The method of claim 18, further comprising the step of visually marking, via a marking apparatus, one or more defective areas of the composite material sheet based at least in part on the inspection data.

20. The method of claim 18, further comprising the step of predicting a defect in the composite material sheet based at least in part on the inspection data and data stored to a database of historic quality data.

21. The method of claim 18, wherein each of the plurality of non-contact ultrasonic sensors comprises an ultrasonic emitter and an ultrasonic receiver, each of the ultrasonic emitter and the ultrasonic receiver being configured to translate along the cutting machine to scan the composite material sheet.
